(19) United States
(12) Patent Application Publication
(10) Pub. No.: US 2008/0311921 A1
(43) Pub. Date: Dec. 18, 2008

(54) COMMUNICATION RESOURCE SIGNALING

(75) Inventors: Michael Eckert, Braunschweig (DE); Achim Luft, Braunschweig (DE); Hyung-Nam Choi, Hamburg (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/764,311

(22) Filed: Jun. 18, 2007

(51) Int. Cl. H04Q 7/20; H04Q 7/00

(52) U.S. Cl. 455/450; 370/329; 370/343; 370/410; 455/509

(57) ABSTRACT

A method for communication resource signaling including determining whether an event has taken place which indicates that communication resources being allocated to a communication terminal for a communication service are currently not needed by the communication terminal for the communication service; and sending a signaling message, if the event has taken place, to the communication terminal indicating that the communication resources continute to be allocated to the communication terminal for the communication service or that the communication resources are no longer allocated to the communication terminal for the communication service.

### BACKGROUND

Embodiments of the invention relate generally to a method for communication resource signaling, a network circuit, a method for using communication resources and a communication terminal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication system according to an embodiment of the invention.

FIG. 2 shows a message flow diagram.

FIG. 3 shows a message flow diagram according to an embodiment of the invention.

FIG. 4 shows a message flow diagram according to an embodiment of the invention.

FIG. 5 shows a message flow diagram according to an embodiment of the invention.

FIG. 6 shows a flow diagram according to an embodiment of the invention.

FIG. 7 shows a network circuit according to an embodiment of the invention.

FIG. 8 shows a flow diagram according to an embodiment of the invention.

FIG. 9 shows a communication terminal according to en embodiment of the invention.

### DESCRIPTION

According to one embodiment of the invention, a method for communication resource signaling is provided including determining whether an event has taken place which indicates that communication resources being allocated to a communication terminal for a communication service are currently not needed by the communication terminal for the communication service and sending a signaling message, if the event has taken place, to the communication terminal indicating that the communication resources continute to be allocated to the communication terminal for the communication service or that the communication resources are no longer allocated to the communication terminal for the communication service.

According to another embodiments of the invention, a network circuit according to the method for communication resource signaling described above is provided.

According to another embodiment of the invention, a method for using communication resources is provided including indicating that communication resources being allocated to a communication terminal for a communication service are currently not needed by the communication terminal for the communication service and receiving a message indicating that the communication resources continute to be allocated to the communication terminal for the communication service or that the communication resources are no longer allocated to the communication terminal for the communication service.

According to another embodiments of the invention, a communication terminal according to the method for using communication resources described above is provided.

Illustratively, it is for example signalled to a communication terminal whether communication resources that have been allocated to the communication terminal are still allocated to the communication terminal after it has been decided that the communication terminal (at least currently) does no longer have need of the communication terminals. This may for example be decided because the communication terminal has signalled it or because the communication terminal has stopped using the radio resources, for example has finished with a data transmission. The signaling message for example includes the information that the radio resources are no longer allocated to the communication terminal and no message is sent if the radio resources remain to be allocated to the communication terminal. Thus, when no signaling message is received, e.g. by the communication terminal, it is known that the radio resources remain to be allocated to the communication terminal and may for example be used by the communication terminal without re-requesting radio resources for the communication service.

Analogously, it may also be the case that the signaling message includes the information that the radio resources remain to be allocated to the communication terminal and no message is sent if the radio resources are no longer allocated to the communication terminal.

In one embodiment the method for communication resource signaling further includes deciding whether the communication resources should continue to be allocated to the communication terminal for the communication service or whether the communication resources should be no longer allocated to the communication terminal for the communication service. The communication service is for example provided by a cellular communication network and the decision is for example based on the availability of communication resources in a radio cell of the communication network in which the communication terminal is located. The decision may for example be based on the radio resource situation in the radio cell, e.g. on the availability of radio resources and the quality of radio resources available in the radio cell, for example the interference situation in the radio cell.

The decision is for example carried out by a network circuit of the communication network, e.g. a circuit that is part of a radio access network of the communication network.

For example, the communication terminal is a mobile communication terminal being located in a radio cell of a mobile communication network, the communication service is provided by the mobile communication network and the decision is based on the availability of communication resources in the radio cell. The mobile communication network is for example a mobile communication network according to UMTS (Universal Mobile Telecommunications Service), GSM (Global System for Mobile Communications), FOMA (Free of Mobile Access) or CDMA2000 (CDMA: Code Division Multiple Access).

In one embodiment, the communication resources are radio resources, for example OFDM radio resources.

The communication service is for example a data transmission service.

In one embodiment, the communication service is provided by a communication network and the event is the reception of a message indicating that the communication resources are currently not needed by the communication terminal for the communication service by a network circuit of the communication network or the event is that a network circuit of the communication network detects that the communication terminal is no longer sending application data by means of the communication service. Application data is for example data that is not part of the protocol overhead, e.g. speech data or video data.

The communication service is for example a speech data transmission service, e.g. a voice over IP communication service. The communication service may also be another communication service, for example a service for sending/receiving text messages or video messages or a service for browsing web sites of downloading content from the Internet.

The network circuit is for example part of a base station of a mobile communication system.

In one embodiment it is indicated that communication resources being allocated to the communication terminal for the communication service are currently not needed by the communication terminal for the communication service by sending a message comprising the information that the communication resources are currently not needed by the communication terminal for the communication service or by pausing the usage of the communication service, e.g. quitting the sending of useful data using the communication service.

A memory used in the embodiments of the invention may be be a volatile memory, for example a DRAM (Dynamic Random Access Memory) or a non-volatile memory, for example a PROM (Programmable Read Only Memory), an EPROM (Erasable ROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

A circuit can be a hardware circuit, e.g. an integrated circuit, designed for the respective functionality or also a programmable unit, such as a processor, programmed for the respective functionality.

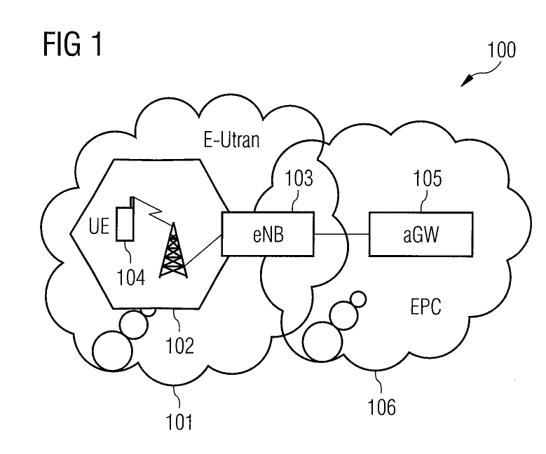

FIG. 1 shows a communication system 100 according to an embodiment of the invention. The communication system includes a radio access network 101 and a core network 106. The service area of the radio access network 101 is divided into radio cells. For simplicity, only one radio cell 102 is shown, but there may be an arbitrary number of radio cells 102. The region of the service area that corresponds to the radio cell 102 is served by a base station 103. A mobile terminal 104 located in the radio cell 102 can communicate with the base station 103. For example, the base station 103 may provide access for the mobile terminal 104 to the core network 102 by means of an access gateway 105 which may be part of the core network 106.

In one embodiment, the communication system 100 is a communication system according to LTE (Long Term Evolution). LTE refers to an advanced UMTS mobile communication system that is currently been developed. In an LTE system, i.e. a system according to LTE, data transmission is based on the multiple access method OFDMA (orthogonal frequency division multiple access) for downlink data transmission and SC-FDMA (single carrier frequency division multiple access) for uplink data transmission.

According to LTE, the radio access network 101 is called E-UTRAN (evolved UMTS terrestrial radio access network), the base station 103 is called eNB and the core network is called evolved packet core (EPC).

Currently, the efficient scheduling and dynamic distribution of radio resources for the data transmission in uplink and downlink in the radio cells is discussed in the standardisation team 3GPP (3rd Generation Partnership Project) TSG RAN WG2 for LTE systems. One of the objects in this discussion is that a mobile terminal can be signalled with as few signaling data as necessary which radio resources it may use for data transmission in uplink (i.e. for transmitting data to a base station). Therein, a major issue is the optimisation of the uplink scheduling (i.e. the distribution of radio resources for uplink data transmission) for the data transmission in communication connections which are used for transmitting speech data based on the internet protocol (voice over internet protocol, VoIP), i.e. for data transmission for a VoIP communication service.

When the user of a mobile terminal 104 uses a VoIP communication service and is currently speaking, i.e. wants to transmit speech data to another user, speech data are generated and transmitted to the base station 103 in accordance with a fixed time pattern, for example, a speech data packet is transmitted to the base station 103 every 20 ms. In a break, i.e. when the user is currently not speaking, no speech data is generated and transmitted. Therefore, it is inefficient to allocate radio resources permanently for the VoIP communication service since in breaks, the radio resources would be unused and would be wasted. On the other hand if the radio resources are allocated in a completely dynamic way, i.e. the radio resources for each speech data packet are scheduled dynamically, a lot of signaling is necessary.

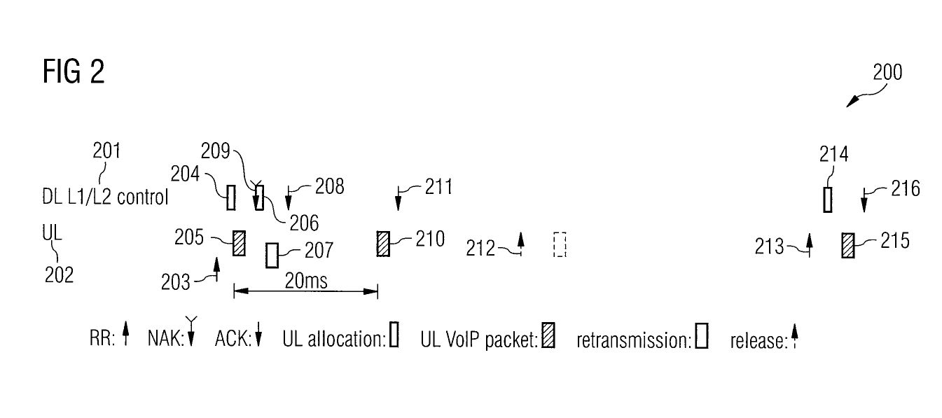

One possibility for the efficient and dynamic distribution of radio resources in a radio cell 102 for data transmission in a VoIP service an uplink according to one embodiment of the invention is illustrated in FIG. 2.

FIG. 2 shows a message flow diagram 200.

In a first row 201 of the message flow diagram 200, downlink messages are shown, i.e. messages transmitted from the base station 103 to the mobile terminal 104. In a second row 202 of the message flow diagram 200 uplink messages are shown, i.e. messages transmitted from the mobile terminal 104 to the base station 103.

In this example, it is assumed that the mobile terminal 104 uses a VoIP service. Time progresses from left to right in the message flow diagram 200 in FIG. 2.

In the beginning (i.e. at the time corresponding to the left end of the message flow diagram 200), it is assumed that the user of the mobile terminal 104 is currently speaking. Therefore, voice data is to be transmitted from the mobile terminal 104 to the base station 103. To do this, the mobile terminal 104 sends a first resource request message 203 to the base station 103 for requesting radio resources for the transmission of speech data packets. The base station 103 may respond to the request with a first radio resource allocation message 204 in which the radio resources allocated for the speech data transmission are specified. These radio resources are for example a frequency range or one or more sub-carriers.

In one embodiment, these radio resources may be used every 20 ms by the mobile terminal 104 to transmit a speech data packet to the base station 103. In this example, the mobile terminal 104 transmits a first speech data packet 205 to the base station 103 using the radio resources specified in the first radio resource allocation message 204 (this time interval may be different in other embodiments, e.g. 10 ms or 40 ms). In this example it is assumed that the first speech data packet 205 has not been properly received by the base station 103. Therefore, the base station 103 transmits a negative acknowledgment message 209 indicating that the first speech data packet 205 has not been properly received at the base station 103 and sends a second radio resource allocation message 206 specifying radio resources which may be used by the mobile terminal 104 for the re-transmission of the first speech data packet 205.

The radio resources allocated for the re-transmission of the first speech data packet 205 may be different from the radio resources allocated for the transmission of speech data packets by the mobile terminal 105. The mobile terminal 104 than re-transmits the first speech data packet 205 in the form of a re-transmitted speech data packet 207.

It is assumed that the re-transmitted speech data packet 207 is correctly received at the base station 103. Therefore, the base station 103 sends a first acknowledge message 208 to the mobile terminal 104. By way of example, 20 ms after the transmission of the first speech data packet 205, the mobile terminal 104 transmits a second speech data packet 210 to the base station 103. It is assumed that the second speech data packet 210 is successfully received by the base station 103. Therefore, the base station 103 responds to the second speech data packet 210 with a second acknowledgment message 211 indicating that the second speech data packet 210 has been properly received. It is assumed that after the second speech data packet 210 has been sent the user of the mobile terminal 104 stops to speak and no speech data is to be transmitted to the base station 103.

In this example for VoIP radio resource allocation the mobile terminal 104 then sends a resource release message 212 to the base station 103 which indicates that the mobile terminal 104 no longer needs the radio resources allocated for speech data packet uplink transmission. The radio resources may then be allocated by the base station 103 to other communication services or other mobile terminals.

When the user of the mobile terminal 104 starts to speak again and speech data is again to be transmitted to the base station 103 the mobile terminal 104 sends a second radio resource request message 213 to the base station 103. Similar to the first radio resource allocation message 204, the base station 103 may respond with a third radio resource allocation message 214 and the process continues analogously as before, for example the mobile terminal 202 sends a third speech data packet 215 to the base station 103 which responds by sending a third acknowledgment message 216.

The procedure for radio resource allocation as it is explained with reference to FIG. 2, i.e. the mobile terminal releases the radio resources allocated for uplink speech data transmission when it has no longer need of these radio resources, may lead unnecessary signaling in the case that the radio resources are not needed for other communication services or other mobile terminals in the radio cell 102, for example in the case when there are few mobile terminals in the radio cell 102 or the mobile terminals in the radio cell 102 produce only little data traffic.

Therefore, in the embodiments described in the following, after receiving a resource release message 212 the base station 103 signals to the mobile terminal 104 whether the radio resources allocated for speech data uplink transmission are no longer allocated for speech data uplink transmission by the mobile terminal 104 (and are for example allocated to other communication services or other mobile terminals) or whether the radio resources continute to be allocated for speech data uplink transmission by the mobile terminal 104.

This has the effect that in situations were radio resources in the radio cell 102 are not scarce, for example when only very few active mobile terminals are located in the radio cell 102, the signaling load can be reduced since radio resources allocated for speech data uplink transmission remain to be allocated for speech data uplink transmission even in speech breaks and it is not necessary for the mobile terminal 104 to re-request radio resources for speech data uplink transmission by sending a resource request message 213 after the speech break. Furthermore, after a speech break the base station 103 does not have to be determine radio resources to be allocated for speech data uplink transmission by the mobile terminal 104 and does not have to signal the allocated radio resources to the mobile terminal 104 (by sending a radio resource allocation message 214) in the case that the radio resources remain to be allocated for speech data uplink transmission even in speech breaks.

In the case where radio resources in the radio cell 102 are scarce, for example when a lot of active mobile terminals are located in the radio cell 102, the base station 103 may signal to the mobile terminal 104 that radio resources are no longer located for speech data uplink transmission in a speech break and thus radio resources may by efficiently allocated in the radio cell 102.

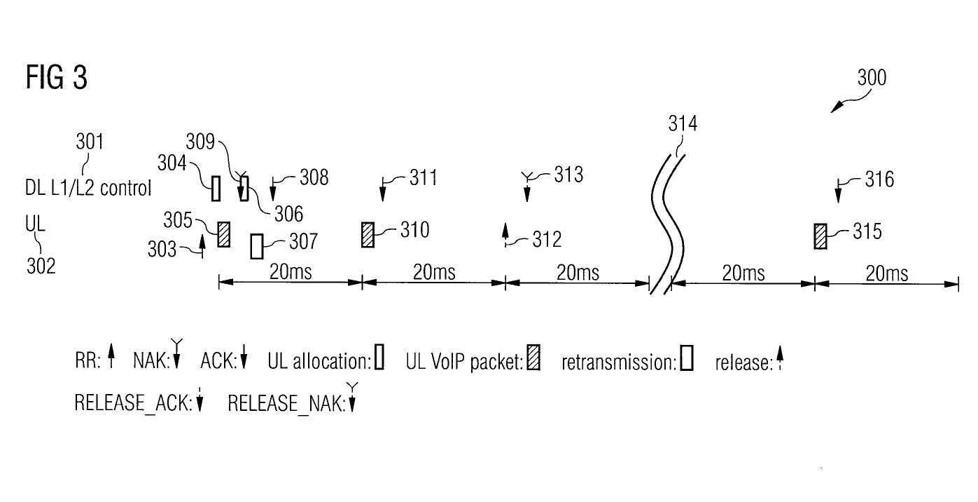

Examples for this procedure are described in the following with reference to FIGS. 3, 4, and 5.

FIG. 3 shows a message flow diagram 300 according to an embodiment of the invention.

Analogously to the message flow diagram 200 shown in FIG. 2, the message flow diagram 300 shows downlink messages (i.e. messages transmitted from the base station 103 to the mobile terminal 104) in a first row 301 and messages transmitted in uplink (i.e. messages transmitted from the mobile terminal 104 to the base station 103) in a second row 302. A first resource request message 303, a first radio resource allocation message 304, a first speech data packet 305, a negative acknowledgment message 309, a second resource allocation message 306, a re-transmitted speech data packet 307, a first acknowledgment message 308, a second speech data packet 310, and a second acknowledgment message 311 are transmitted as is explained with reference to FIG. 2 (analogously to the messages 203 to 211).

As in the example described with reference to FIG. 2, it is assumed that after the transmission of the second speech data packet 310 there is a speech break and the mobile terminal 104 currently does not need to transmit speech data in uplink to the base station 103. Therefore, the mobile terminal 104 sends a resource release message 312 to the base station 103.

After the reception of the indication that the mobile terminal 104 does no longer have to send speech data to the base station 103 the base station signals to the mobile terminal 104 whether the radio resources allocated for speech data uplink transmission by the mobile terminal 104 continute to be allocated for speech data uplink transmission by the mobile terminal 104 or are no longer allocated for speech data uplink transmission by the mobile terminal 104.

In this example, it is assumed that it is decided that the radio resources allocated for speech data uplink transmission by the mobile terminal 104 may continue to be allocated for speech data uplink transmission by the mobile terminal 104, for example due to the fact that radio resources are not scarce in the radio cell 102. Therefore, the base station 103 sends a negative release acknowledgment message 313 to the mobile terminal 104 which indicates that the radio resources allocated to the mobile terminal 104 for speech data uplink transmission continute to be allocated to the mobile terminal 104 for speech data uplink transmission.

It is assumed that after a certain time period 314 the speech break has ended and the mobile terminal 104 again needs to transmit speech data to the base station 103. Therefore, the mobile terminal 104 sends a third speech data packet 315 to the base station 103. It is assumed that the third speech data packet is successfully received by the base station 103. Therefore, the base station 103 responds with a third acknowledgment message 316.

Since the radio resources allocated for speech data uplink transmission by the mobile terminal 104 are allocated during the whole time period 314 for speech data uplink transmission by the mobile terminal 104 the base station 103 checks during the time period 314 whether the mobile terminal 104 is transmitting speech data packets using the radio resources allocated for speech data uplink transmission by the mobile terminal 104 because the mobile terminal 104 could start to send speech data packets using the radio resources at any time during the time period 314 (or at least at certain time points in the time period 314, for example every 20 ms).

In one embodiment, the resource release message 312 is not explicitly sent but the base station 103 determines that there is a speech break and the radio resources are currently not needed by the mobile terminal 104 if the mobile terminal 104 stops to send speech data packets to the base station 103, i.e. the mobile terminal 104 does not send a speech data packet to the base station 103 at a time point where it would send a speech data packet if there was no speech break, for example 20 ms after the transmission of the second speech data packet 310.

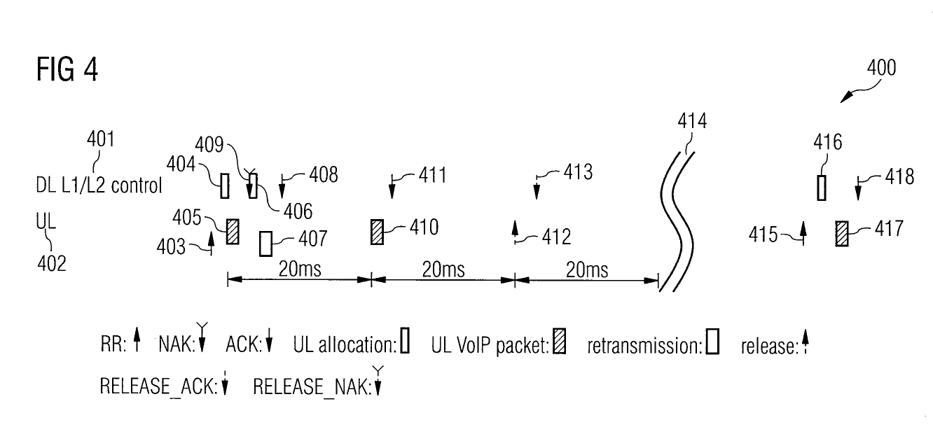

Since in the example described with reference to FIG. 3 the radio resources allocated to the mobile terminal 104 continute to be allocated to the mobile terminal 104 for speech data uplink transmission during the time period 314 the mobile terminal 104 does not have to send another resource request message before sending the third speech data packet 315 to the base station 103 using the radio resources. An example where the radio resources are no longer allocated to the mobile terminal 104 for speech data uplink transmission during a speech break is explained in the following with reference to FIG. 4.

FIG. 4 shows a message flow diagram 400 according to an embodiment of the invention.

Analogously to the message flow diagram shown in FIG. 3, downlink messages are shown in a first row 401 of the message flow diagram 400 and uplink message are shown in a second row 402 of the message flow diagram 400. A first resource request message 403, a first resource allocation message 404, a first speech data packet 405, a negative allocation message 409, a second resource allocation message 406, a re-transmitted speech data packet 407, a first acknowledgment message 408, a second speech data packet 410, a second acknowledgment message 411, and a release request message 412 are transmitted as is explained with reference to FIG. 2 and FIG. 3.

In this example, it is assumed that the radio resources allocated to the mobile terminal 104 for speech data uplink transmission should not be allocated to the mobile terminal 104 for speech data uplink transmission in case of a speech break, for example since a lot of active mobile terminals are located in the radio cell 102. Therefore, the base station 103 may respond to the release request message 412 with a release acknowledgment message 413 indicating that the mobile terminal 105 may no longer use the radio resources which were allocated for speech data uplink transmission.

It is assumed that after a certain time period 414 the speech break is ended and this means that the user of the mobile terminal 104 starts to speak and speech data is to be transmitted to the base station 103. Since the radio resources which were allocated to the mobile terminal 104 for speech data uplink transmission are no longer allocated to the mobile terminal 104 for speech data uplink transmission and have for example been re-allocated to other communication services or other communication terminals, the mobile terminal 104 sends a second resource request message 415 to the base station 103.

The base station 103 responds with a third radio resource allocation message 416 specifying radio resources which may be used by the mobile terminal 104 for speech data uplink transmission. Using these radio resources, the mobile terminal 104 sends a third speech data packet 417 to the base station 103 which is assumed to be successfully received at the base station 103 and therefore is answered with a third acknowledgment message 418.

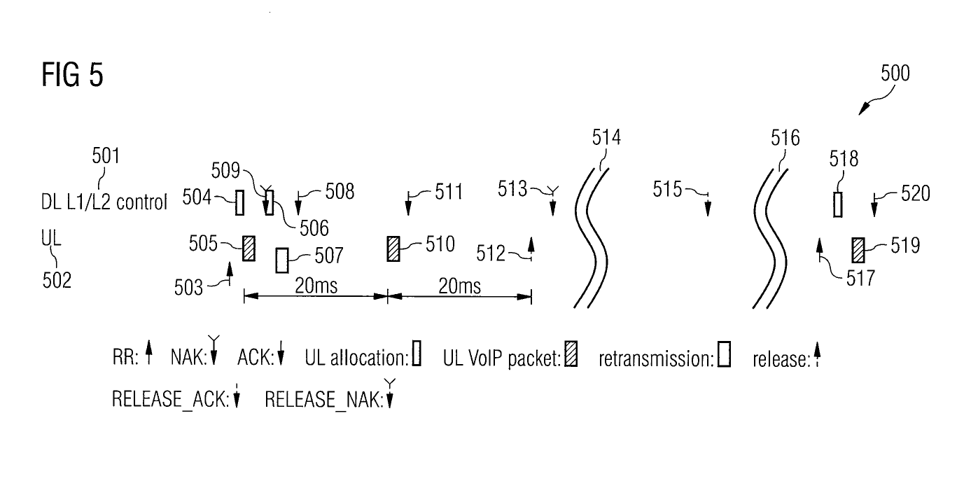

It may also be the case that in a speech break initially the radio resources continute to be allocated to the mobile terminal 104 for speech data uplink transmission but after a time it is decided that they should no longer be allocated to the mobile terminal 104 for speech data uplink transmission. This is explained in the following with reference to FIG. 5.

FIG. 5 shows a message flow diagram 500 according to an embodiment of the invention.

Analogously to FIGS. 2, 3, and 4 in the message flow diagram 500 there are shown downlink messages in a first row 501 and uplink messages in a second row 502. A first resource request message 503, a first radio resource allocation message 504, a first speech data packet 505, a negative acknowledgment message 509, a second radio resource allocation message 506, a re-transmitted speech data packet 507, a first acknowledgment message 508, a second speech data packet 510, a second acknowledgment message 511 and a release request message 512 are transmitted as is explained with reference to FIGS. 2 and 3.

It is assumed that it is decided that the radio resources allocated to the mobile terminal 104 for uplink speech data transmission should remain to be allocated in a speech break following the transmission of the second speech data packet 510. Therefore, the base station transmits a negative release acknowledgment message 513 to the mobile terminal 104 which indicates that the radio resource allocated to the mobile terminal 105 for uplink speech data transmission continute to be allocated to the mobile terminal 105 for uplink speech data transmission.

It is assumed that after a first time period 514, it is decided that the radio resources allocated to the mobile terminal 105 for speech data uplink transmission should no longer be allocated to the mobile terminal 104 for speech data uplink transmission, for example due to the fact that the radio resources in the radio cell 102 are becoming scarce because the number of active mobile terminals 102 has increased during the first time period 514.

Therefore, the base station 103 sends a release acknowledgment message 515 to the mobile terminal 104 indicating that the radio resources previously allocated to the mobile terminal 104 for speech data uplink transmission are no longer allocated to the mobile terminal 104 for speech data uplink transmission. Consequently, after a second time period 516 after which the speech break is assumed to have ended, the mobile terminal 104 re-requests radio resources for speech data uplink transmission and, for example, a second resource request message 517, a third radio resource allocation message 518, a third speech data packet 519 and a third acknowledgment message 520 are transmitted as is explained with reference to FIG. 4.

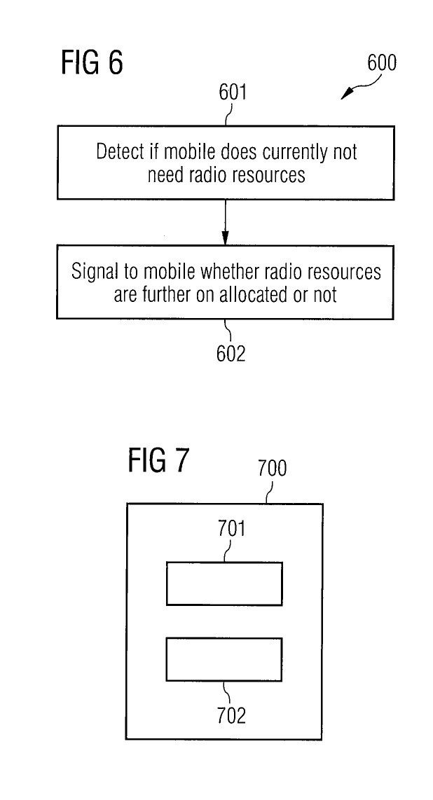

Embodiments of the invention are described in the following with reference to FIGS. 6, 7, 8 and 9.

FIG. 6 shows a flow diagram 600 according to an embodiment of the invention. The flow diagram 600 illustrates a method for communication resource signaling according to an embodiment of the invention.

In 601, it is determined whether an event has taken place which indicates that communication resources being allocated to a communication terminal for a communication service are currently not needed by the communication terminal for the communication service.

In 602, if the event has taken place, a signaling message is sent to the communication terminal indicating that the communication resources continute to be allocated to the communication terminal for the communication service or that the communication resources are no longer allocated to the communication terminal for the communication service.

FIG. 7 shows a network circuit 700 according to an embodiment of the invention.

The network circuit 700 includes a determination circuit 701 determining whether an event has taken place which indicates that communication resources being allocated to a communication terminal for a communication service are currently not needed by the communication terminal for the communication service.

Further, the network circuit 700 includes a sending circuit 702 sending, if the event has taken place, a signaling message to the communication terminal indicating that the communication resources continute to be allocated to the communication terminal for the communication service or that the communication resources are no longer allocated to the communication terminal for the communication service.

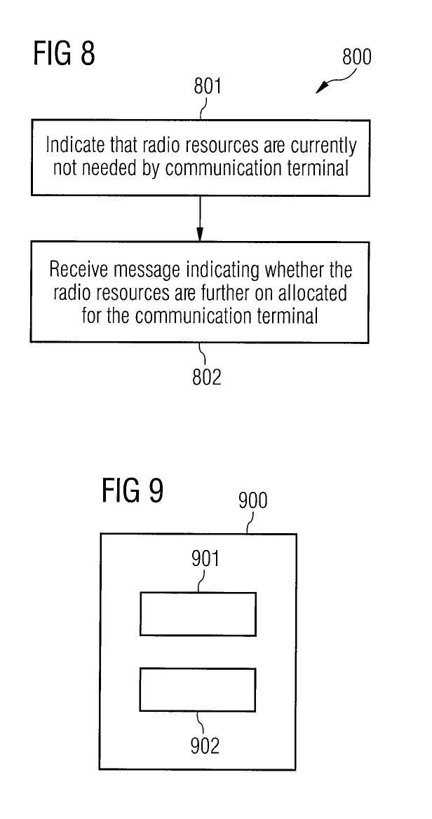

FIG. 8 shows a flow diagram 800 illustrating a method for using communication resources according to an embodiment of the invention.

In 801, it is indicated that communication resources being allocated to a communication terminal for a communication service are currently not needed by the communication terminal for the communication service.

In 802, a message is received indicating that the communication resources continute to be allocated to the communication terminal for the communication service or that the communication resources are no longer allocated to the communication terminal for the communication service.

FIG. 9 shows a communication terminal 900 in accordance with an embodiment of the invention.

The communication terminal 900 includes an indicating circuit 901 indicating that communication resources being allocated to a communication terminal for a communication service are currently not needed by the communication terminal for the communication service.

Further, the communication terminal 900 includes a receiving circuit 902 receiving a message indicating that the communication resources continute to be allocated to the communication terminal for the communication service or that the communication resources are no longer allocated to the communication terminal for the communication service.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for communication resource signaling comprising:
determining whether an event has taken place which indicates that communication resources allocated to a communication terminal for a communication service are currently not needed by the communication terminal for the communication service; and
sending a signaling message, if the event has taken place, to the communication terminal indicating that the communication resources continute to be allocated to the communication terminal for the communication service or that the communication resources are no longer allocated to the communication terminal for the communication service.

2. The method according to claim 1, further comprising deciding whether the communication resources should continue to be allocated to the communication terminal for the communication service or whether the communication resources should no longer be allocated to the communication terminal for the communication service.

3. The method according to claim 2, wherein the communication service is provided by a cellular communication network and the decision is based on availability of communication resources in a radio cell of the communication network in which the communication terminal is located.

4. The method according to claim 3, wherein the decision is carried out by a network circuit of the communication network.

5. The method according to claim 2, wherein the communication terminal is a mobile communication terminal located in a radio cell of a mobile communication network, the communication service is provided by the mobile communication network and the decision is based on availability of communication resources in the radio cell.

6. The method according to claim 1, wherein the communication resources are radio resources.

7. The method according to claim 1, wherein the communication resources are OFDM radio resources.

8. The method according to claim 1, wherein the communication service is a data transmission service.

9. The method according to claim 1, wherein the communication service is provided by a communication network and the event is the reception of a message indicating that the communication resources are currently not needed by the communication terminal by a network circuit of the communication network for the communication service or the event is that a network circuit of the communication network detects that the communication terminal is no longer sending application data by means of the communication service.

10. The method according to claim 1, wherein the communication service is a speech data transmission service.

11. The method according to claim 1, wherein the communication service is voice over IP.

12. A network circuit comprising:
a determination circuit configured to determine whether an event has taken place which indicates that communication resources being allocated to a communication terminal for a communication service are currently not needed by the communication terminal for the communication service; and
a sending circuit configured to send, if the event has taken place, a signaling message to the communication terminal indicating that the communication resources continue to be allocated to the communication terminal for the communication service or that the communication resources are no longer allocated to the communication terminal for the communication service.

13. The network circuit according to claim 12, being part of a base station of a mobile communication system.

14. The network circuit according to claim 12, further comprising a deciding circuit configured to decide whether the communication resources should continue to be allocated to the communication terminal for the communication service or whether the communication resources should no longer be allocated to the communication terminal for the communication service.

15. The network circuit according to claim 14, wherein the communication service is provided by a cellular communication network and the decision is based on availability of communication resources in a radio cell of the communication network in which the communication terminal is located.

16. The network circuit according to claim 14, wherein the communication terminal is a mobile communication terminal located in a radio cell of a mobile communication network, the communication service is provided by the mobile communication network and the decision is based on availability of communication resources in the radio cell.

17. The network circuit according to claim 12, wherein the communication resources are radio resources.

18. The network circuit according to claim 17, wherein the communication resources are OFDM radio resources.

19. The network circuit according to claim 12, wherein the communication service is a data transmission service.

20. The network circuit according to claim 12, wherein the event is a reception of a message indicating that the communication resources are currently not needed by the communication terminal for the communication service or the event is a detection that the communication terminal is no longer sending application data by means of the communication service.

21. The network circuit according to claim 12, wherein the communication service is a speech data transmission service.

22. The network circuit according to claim 12,wherein the communication service is voice over IP.

23. A method for using communication resources comprising:
indicating that communication resources being allocated to a communication terminal for a communication service are currently not needed by the communication terminal for the communication service; and
receiving a message indicating that the communication resources continue to be allocated to the communication terminal for the communication service or that the communication resources are no longer allocated to the communication terminal for the communication service.

24. The method according to claim 23, wherein the indicating step comprises sending a message including information that the communication resources are currently not needed by the communication terminal for the communication service or pausing usage of the communication service.

25. The method according to claim 23, wherein the communication resources are radio resources.

26. The method according to claim 25, wherein the communication resources are OFDM radio resources.

27. The method according to claim 23, wherein the communication service is a data transmission service.

28. The method according to claim 23, wherein the communication service is a speech data transmission service.

29. The method according to claim 23, wherein the communication service is voice over IP.

30. A communication terminal comprising:
an indicating circuit configured to indicate that communication resources being allocated to the communication terminal for a communication service are currently not needed by the communication terminal for the communication service; and
a receiving circuit configured to receive a message indicating that the communication resources continue to be allocated to the communication terminal for the communication service or that the communication resources are no longer allocated to the communication terminal for the communication service.

31. The communication terminal according to claim 30, wherein the indicating circuit is further configured to send a message comprising information that the communication resources are currently not needed by the communication terminal for the communication service or configured to pause usage of the communication service.

32. The communication terminal according to claim 30, wherein the communication resources are radio resources.

33. The communication terminal according to claim 32, wherein the communication resources are OFDM radio resources.

34. The communication terminal according to claim 30, wherein the communication service is a data transmission service.

35. The communication terminal according to claim 30, wherein the communication service is a speech data transmission service.

36. The communication terminal according to claim 30, wherein the communication service is voice over IP.
